(19) United States
(12) Patent Application Publication
(10) Pub. No.: US 2003/0040688 A1
(43) Pub. Date: Feb. 27, 2003

(54) Massage ball as well as massage device with massage balls

(76) Inventor: Dirk Bauer, Bremen (DE)

Correspondence Address: McGLEW AND TUTTLE, P.C., SCARBOROUGH STATION, SCARBOROUGH, NY, 10510-0827, US

(21) Appl. No.: 09/967,360

(22) Filed: Sep. 28, 2001

(30) Foreign Application Priority Data
Aug. 27, 2001 (DE) 201 13 738.0

(51) Int. Cl. A61H 1/00

(52) U.S. Cl. 601/23

(57) ABSTRACT

A massage ball (10) has an outer hollow ball (12) and an inner ball arranged freely movably therein. An massage device made of a plurality such massage balls (10) is also provided. Such massage devices are introduced into the vagina of the woman and are used to massage and consequently train or strengthen the muscles of the pelvic floor. The massaging effect occurs due to the fact that the massage balls (10) connected to one another move in relation to one another and the inner balls (13) also move within the outer balls (12). To avoid the undesired generation of noise, the inside of the outer hollow ball and/or the outside of the inner ball (13) are provided with a coating (21, 23) consisting of a soft material, preferably an elastomer.

### FIELD OF THE INVENTION

The present invention pertains to a massage ball with an outer hollow ball, in which an inner ball is arranged freely movably. Furthermore, the present invention also pertains to a massage device comprising two or more massage balls that are connected to one another with an outer hollow ball, in which an inner ball is arranged freely movably.

### BACKGROUND OF THE INVENTION

Such massage balls and massage devices manufactured with the use of such massage balls have been known from Chinese medicine for thousands of years.

Specifically, the massage devices are designed such that another, heavy ball is arranged in an outer, hollow ball, and is freely movable there. Two of the massage balls designed in such a manner are connected to form the massage device via a cord.

These massage devices were used already in Chinese medicine but also later in other cultures for training the muscles of the pelvic floor in women. The massage device is introduced for this purpose into the vagina of the woman. The two balls connected to one another by the cord move in relation to one another and the movable balls arranged within the hollow balls also move within the hollow balls due to the woman's movement (walking, running, climbing steps, etc.). A massaging effect strengthening the muscles of the pelvic floor is achieved as a result.

The fields of application of such massage devices have been the restoration of the pelvic floor after childbirth or the preventive treatment of incontinence. More recently (in the mid-1950s), application for erotic purposes has also been added, namely, with the background that a woman with the pelvic floor strengthened by the massage device can better control the man during sexual intercourse.

Modern massage devices of the type described in the introduction are manufactured with outer balls made of a hard plastic and an inner ball made of metal which is located therein. As was mentioned, two of these massage balls are connected to one another by a cord. The inner ball is made of metal so that it has a favorable heavy weight for the massaging effect. The drawback of this design is that the inner metal balls fall against the relatively hard plastic inner surface of the outer ball. As a result, noise (“clinking”) is generated, which is audible to bystanders. This is, of course, perceived by the user to be unpleasant, so that the massage device is used in the user's private environment only. However, this leads to an interruption in the use of the massage device in time, as a result of which the success of the use of the massage device is considerably delayed.

### SUMMARY AND OBJECTS OF THE INVENTION

Based on this, the basic object of the present invention is to improve massage balls of the type mentioned in the introduction and massage devices with such massage balls such that they no longer emit noise.

To accomplish this object, the massage ball according to the present invention and the massage device according to the present invention have and outer hollow ball inside and/or the outside of the inner ball provided with a coating consisting of a soft material. This coating is preferably made of an elastomer.

Due to the soft coating, the inner ball is cushioned during the fall against the inner surface of the outer ball and the generation of a clinking noise is avoided as a result. The use of the massage device is no longer audible to bystanders. The effect according to the present invention is achieved regardless of whether the coating is applied to the inner surface of the outer, hollow ball only, to the outer surface of the inner ball only or to both the inner surface of the outer ball and the outer surface of the inner ball.

According to another variant of the present invention, which is also conceivable independently from this, the cord for connecting the massage balls to one another has a thickening, especially a spherical thickening, at each of its ends. The thickening of each end snaps into a corresponding locking hole on the respective massage balls. The cord is thus securely anchored to the massage balls. If the locking hole and the thickenings additionally also have press fit with one another, the holes in the massage balls, through which the cord is led, are sealed at the same time. This sealing effect is especially good because of the soft and elastic coating if the locking hole is arranged in the coating of the outer balls. Body fluid or water (the balls are cleaned under running water after use) is prevented by the good sealing effect from entering the interior of the outer ball. Consequently, the balls according to the present invention are also improved by the variant from a hygienic viewpoint. The balls can even be used during menstruation. The thickening is formed in an especially simple manner by a small plastic ball injection-molded on the cord. As an alternative, the cords may be fastened to the massage balls by crimped sleeves made of plastic, which are fastened to the ends of the cord by crimping. The plastic crimped sleeves may be additionally bonded to the massage balls, so that the above-described locking connection may be eliminated.

The present invention will be explained in greater detail below on the basis of exemplary embodiments shown in the drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective external view of a massage device with the features of the present invention;

FIG. 2 is a vertical partial sectional view of a first exemplary embodiment of a massage ball for a massage device with the features of the present invention;

FIG. 3 is a vertical partial sectional view of a second exemplary embodiment of a massage ball for a massage device with the features of the present invention;

FIG. 4 is a vertical partial sectional view of another exemplary embodiment of a massage ball for a massage device with the features of the present invention; and

FIG. 5 is a perspective view of a hollow ball for a massage device according to FIG. 2 or 3.

### DESCRIPTION OF THE PREFERRED EMBODIMENTS

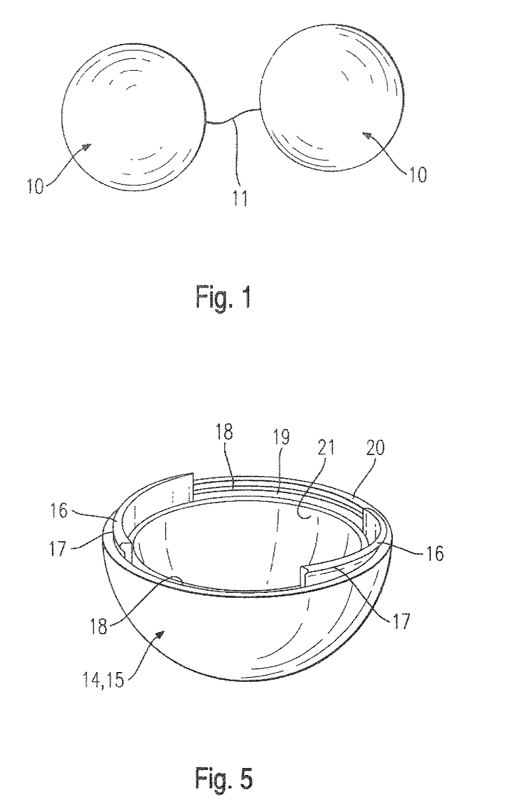

Referring to the drawings in particular, the massage device shown in FIG. 1 comprises two massage balls 10, which are connected to one another by a cord 11. The massage balls 10 themselves are designed as follows.

The massage balls 10 always comprise an outer, hollow ball 12, within which an inner ball 13 is arranged freely movably. The outer, hollow ball 12 has an outside diameter of 34 mm. The inner ball 13 has an outside diameter of about 20 mm and weighs about 20 g.

The outer ball 12 is made of two hemispheres 14, 15, which are clipped to one another. For this purpose, the hemispheres 14, 15 have at their free edge two projections 16 located opposite each other and extending over about 90° with an outer bead 17. With these projections, the hemisphere 14 or 15 engages corresponding recesses 18 on the respective other hemisphere 15 or 14. The outer bead 17 is caught in a corresponding groove 19 on the recess 18. Based on this design and since the projections 16 and recesses 18 extend over 90° each of the angle of the upper edge of the hemispheres 14, 15, two hemispheres 14, 15 of identical design can be fitted together with one another to form the outer ball 12.

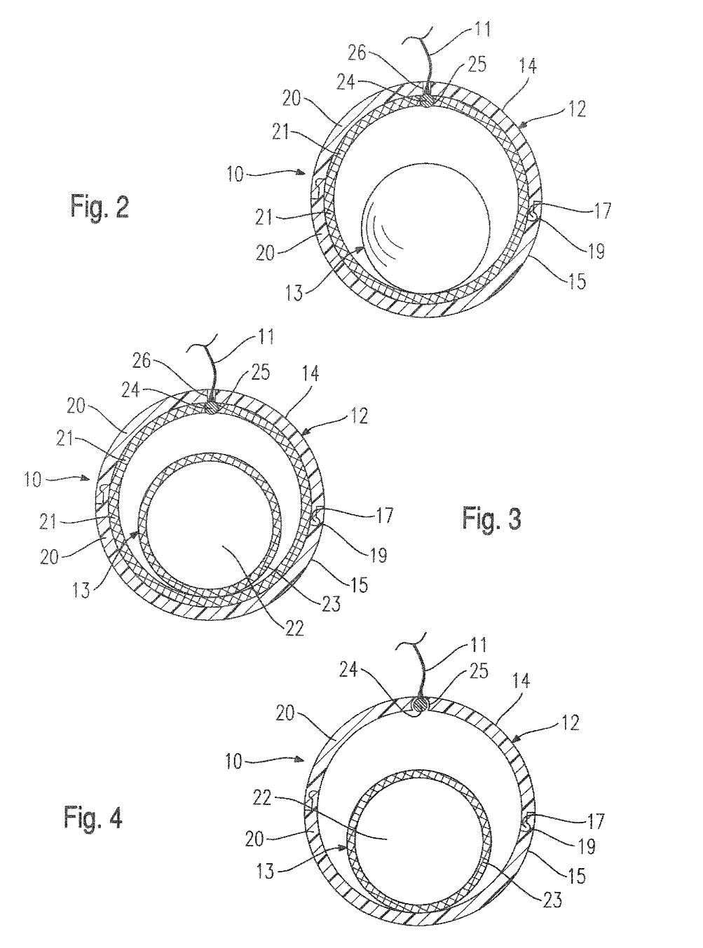

According to a first exemplary embodiment (FIG. 2), the outer ball 12 or its hemispheres 14, 15 have a two-layer design, namely, with an outer shell 20 made of a relatively hard plastic and an inner coating 21 consisting of a soft material, elastic elastomer. The inner ball 13 is a simple metal ball in this exemplary embodiment.

In the exemplary embodiment according to FIG. 3, the outer ball 12 has exactly the same design as in the exemplary embodiment according to FIG. 2. Identical components are therefore designated with the same reference numbers here. However, the inner ball 13 also has a special design in the exemplary embodiment according to FIG. 3, namely, it is made of an inner core 22 made of metal, which is coated with a coating 23 consisting of a soft, elastic elastomer. Thus, both the outer ball 12 and the inner ball 13 are provided with a respective coating 21 and 23 in this exemplary embodiment.

In the exemplary embodiment according to FIG. 4, only the inner ball 13 with the core 22 is made of metal with a coating 23, analogously to the inner ball 13 according to FIG. 3. The outer ball 12 is one-layered, namely, it is made with an outer, relatively hard shell 20 only.

However, the cord 11 is also fastened to the massage balls 10 described so far in a special manner. The cords 11 are provided for this purpose at their ends with a thickening 24 each, namely, a small injection-molded ball made of plastic. This small ball 24 engages a corresponding locking hole 25 on the outer ball 12. The small ball 24 and the locking hole 25 are press-fitted to one another. In the exemplary embodiments according to FIGS. 2 and 3, the locking hole 25 is arranged within the soft, elastic coating 21. The cord 11 is led through the outer shell 20 through an additional hole 26. In the exemplary embodiment according to FIG. 4, the locking hole 25 is arranged directly in the shell 20.

However, the thickening 24 may also be formed by a crimped sleeve made of plastic. This is placed on the ends of the cord 11 and then fastened by crimping in a non-positive manner. The crimped sleeves 24 are then also bonded to the massage ball 10.

While specific embodiments of the invention have been shown and described in detail to illustrate the application of the principles of the invention, it will be understood that the invention may be embodied otherwise without departing from such principles.

### APPENDIX

### List of Reference Numbers

10 Massage ball

11 Cord

12 Ball (outer)

13 Ball (inner)

14 Hemisphere

15 Hemisphere

16 Projection

17 Outer bead

18 Recess

19 Groove

20 Shell

21 Coating

22 Core

23 Coating

24 Thickening

25 Locking hole

26 Hole

What is claimed is:

1. A massage ball, comprising:
an outer hollow ball having an inner surface and an outer surface;
an inner ball arranged freely movably in said outer hollow ball, said inner ball having an outer surface;
a soft material coating provided on one of said outer ball inner surface and said inner ball outer surface.

2. A massage ball in accordance with claim 1, wherein said coating consists of an elastomer.

3. A massage device comprising:
a first massage ball with
a first outer hollow ball having an inner surface and an outer surface,
a first inner ball arranged freely movably in said outer hollow ball, said inner ball having an outer surface,
a first soft material coating provided on one of said first outer ball inner surface and said first inner ball outer surface;
a second massage ball with
a second outer hollow ball having an inner surface and an outer surface,
a second inner ball arranged freely movably in said outer hollow ball, said inner ball having an outer surface,
a second soft material coating provided on one of said outer ball inner surface and said inner ball outer surface, said first massage ball being connected with said second massage ball.

4. A massage device in accordance with claim 3, wherein each of said first coating and said second coating consists of an elastomer.

5. A massage device in accordance with claim 3, further comprising a cord connecting said first massage ball with said second massage ball, said chord having a first end with a thickening and having a second end with a thickening, said first massage ball having locking hole receiving said thickening of said first end and said second massage ball having a locking hole receiving said thickening of said second end.

6. A massage device in accordance with claim 5, wherein said first massage ball locking hole is substantially spherical in shape.

7. A massage device in accordance with claim 5, wherein said thickening of said first end snaps into said first massage ball locking hole for a snap lock holding of said chord to said first massage ball.

8. A massage device in accordance with claim 5, wherein said thickening of said first end is bonded to first massage ball.

9. A massage device in accordance with claim 5, wherein said locking hole and said thickenings are press-fitted to one another.

10. A massage device in accordance with claim 5, wherein said locking hole is arranged in said coating of said outer balls.

11. A massage device in accordance with claim 5, wherein said thickening comprises one of a small plastic ball injection-molded on said cord or a crimped plastic sleeve.
